(19) United States
(12) Patent Application Publication
(10) Pub. No.: US 2009/0288524 A1
(43) Pub. Date: Nov. 26, 2009

(54) Rodrunner

(76) Inventor: Jayson Michael Vasi, Hemet, CA (US)

Correspondence Address: Jayson Michael Vasi, 5068 Merlyn Street, Hemet, CA, 92544-5185, US

(21) Appl. No.: 12/154,418

(22) Filed: May 23, 2008

(51) Int. Cl. B25B 23/00

(52) U.S. Cl. 81/180.1

(57) ABSTRACT

In a Commercial/Industrial setting there can be several hundred threaded rods hanging from the ceiling for hundreds of linear feet of support runs for everything from conduit to cabling trays. These are secured to the threaded rods which are anchored into the ceding and can be at least ten feet long and in excess of twelve feet high. The Rodrunner worked very well and saved me time by not having to spin the nut on by hand and I can conceivably work from the floor rather than on a lift or ladder which also brings into account safety issues.

### BACKGROUND

I am a Union Electrician and my job requires installing cable tray and conduit runs at heights in excess of twelve feet. Support runs are frequently used for a number of applications and require “stacked” levels. Each level must be secured on the rod and the nuts for the top level will of course be substantially further up the rod than the last level.

### SUMMARY

The intent is to spin a hex nut onto threaded rod of great length rather than using ones fingers. For example this device would save substantial time in a case where the threaded rod is suspended from the ceiling for the use of support and the nuts are the stop and/or are a component for a bracket.

### DESCRIPTION

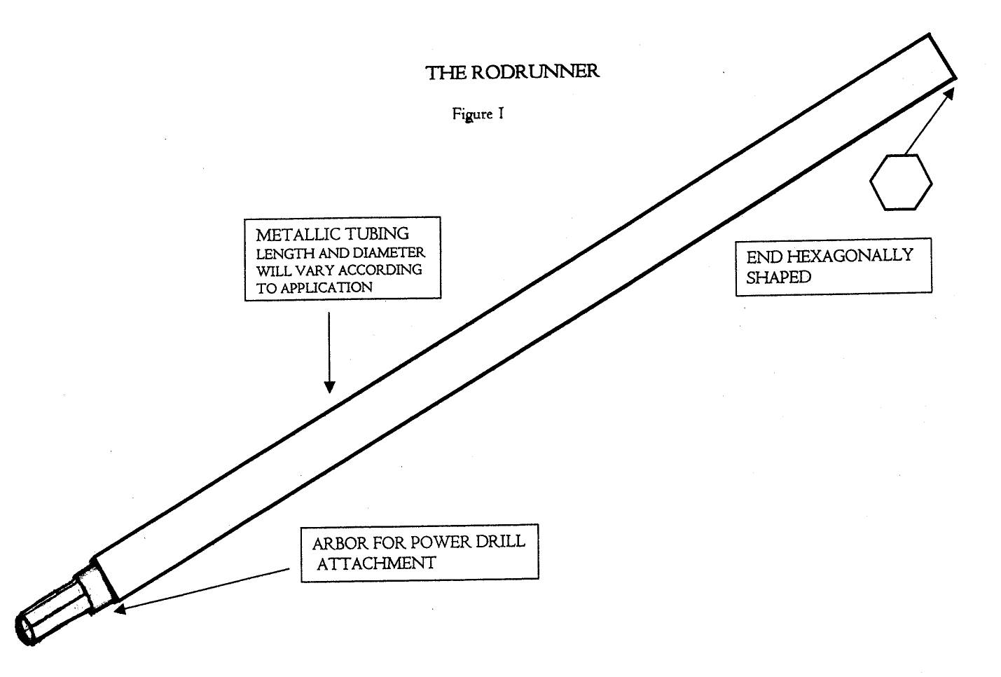

See FIG. 1 (not to scale)

The Rodrunner is a tubular (metallic) device hexagonally shaped on one end to fit one or more hex nuts. The other end will be fitted with an arbor that is permanently affixed or interchangeable to allow attachment to a power drill. The length and diameter will vary according to the specific application.

1. The Rodrunner is a tool which the primary use would be for Commercial and/or Industrial construction. It is in this setting that I fashioned the first prototype using a scrap piece of conduit with the end shaped to fit the nut and affixed it to my drill. It worked so well and saved so much time that several of my co-workers suggested that I should Patent it.
